(19) United States
(12) Patent Application Publication
(10) Pub. No.: US 2012/0194094 A1
(43) Pub. Date: Aug. 2, 2012

(54) LIGHT-EMITTING DEVICE

(76) Inventors: Liu Hsin-Mao, Hsinchu City (TW); Chao Kuang-Ping, Hsinchu City (TW)

(21) Appl. No.: 13/018,770

(22) Filed: Feb. 1, 2011

(51) Int. Cl. H05B 37/02

(52) U.S. Cl. 315/291

(57) ABSTRACT

This disclosure discloses a light-emitting device adapted for receiving an alternating current signal from a power source. The light-emitting device comprises: a rectifying unit for receiving and regulating the alternating current signal into a first direct current signal; a first capacitor electrically connected in parallel with the rectifying unit and for receiving and regulating the first direct current signal to a second direct current signal; and a light-emitting unit electrically connected in parallel with the first capacitor and receiving the second direct current signal. The second direct current signal is a periodic signal, and the second direct current signal has a maximum voltage and a minimum voltage. The voltage difference between the maximum and minimum voltages is less than 5% of the maximum voltage in one cycle of the periodic signal.

### BACKGROUND

1. Technical Field

The present disclosure relates to a light-emitting device, and in particular to a light-emitting device comprising a capacitor.

2. Description of the Related Art

The light-emitting diodes (LEDs) of the solid-state lighting elements have the characteristics of the low power consumption, low heat generation, long operational life, shockproof, small volume, quick response and good opto-electrical property like light emission with a stable wavelength, so the LEDs have been widely used in household appliances, indicator light of instruments, and opto-electrical products, etc. As the opto-electrical technology develops, the solid-state lighting elements have great progress in the light efficiency, operation life and the brightness, and LEDs are expected to become the main stream of the lighting devices in the near future.

Generally speaking, the conventional LED is driven by direct current (DC). An AC-DC converter is required to convert AC to DC. Since the converter has a large volume and heavy weight, the cost is added and the power is loss during converting. In addition, the converter includes a plurality of electronic elements which are configured to form a complex topology.

### SUMMARY OF THE DISCLOSURE

The present disclosure provides a light-emitting device adapted for receiving an alternating current signal from a power source.

The light-emitting device comprises: a rectifying unit for receiving and regulating the alternating current signal into a first direct current signal; a first capacitor electrically connected in parallel with the rectifying unit for receiving and regulating the first direct current signal to a second direct current signal; and a light-emitting unit electrically connected in parallel with the first capacitor and receiving the second direct current signal. The second direct current signal is a periodic signal, and the second direct current signal has a maximum voltage and a minimum voltage. The voltage difference between the maximum and minimum voltages is less than 5% of the maximum voltage in one cycle of the periodic signal.

### BRIEF DESCRIPTION OF THE DRAWINGS

The accompanying drawings are included to provide easy understanding of the application, and are incorporated herein and constitute a part of this specification. The drawings illustrate the embodiments of the application and, together with the description, serve to illustrate the principles of the application.

FIG. 1 shows a circuit diagram of a light-emitting device in accordance with the first embodiment of the present disclosure.

FIG. 2A is a voltage waveform diagram that illustrate an alternating current signal from an alternating current power source.

FIG. 2B is a voltage waveform diagram that illustrates a pulsed current signal rectified by a rectifying unit.

FIG. 2C is a voltage waveform diagram that illustrates a smoothing direct current signal regulated by a capacitor.

FIG. 3 shows a circuit diagram of the light-emitting device of the present disclosure, including a current-limiting resistor.

FIG. 4 shows a cross-sectional view of the capacitor embodied in the first embodiment of the present disclosure.

FIG. 5 shows a circuit diagram of a light-emitting device in accordance with the second embodiment of the present disclosure.

### DETAILED DESCRIPTION OF THE EMBODIMENTS

To better and concisely explain the disclosure, the same name or the same reference number given or appeared in different paragraphs or figures along the specification should has the same or equivalent meanings while it is once defined anywhere of the disclosure.

The following shows the description of the embodiments of the present disclosure in accordance with the drawings.

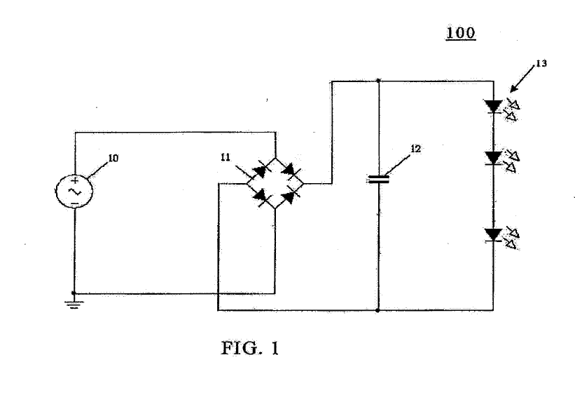

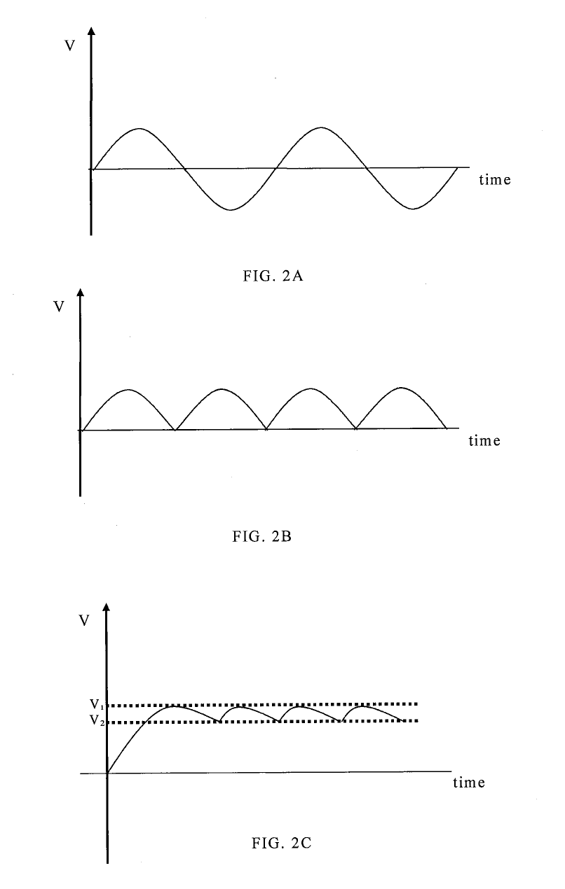

FIG. 1 discloses a light-emitting device 100 according to the first embodiment of the present disclosure. The light-emitting device 100 comprises an alternating current power source 10 for providing an alternating current signal, a rectifying unit 11 electrically connected with the power source 10 for receiving and regulating the alternating current signal (FIG. 2A) into a first direct current signal (FIG. 2B), a first capacitor 12 for receiving and regulating the first direct current signal into a second direct current signal (FIG. 2C), and a light-emitting unit 13 electrically connected in parallel with the first capacitor 12 and receiving the second direct current signal for emitting light. In this embodiment, the first direct current signal is a pulsed direct current signal, as shown in FIG. 2B, and the second direct current signal is a smoothing direct current signal, which is a periodic signal as shown in FIG. 2C. For example, the alternating current power source 10 provides a voltage having a root mean square value of 110V, which has a peak voltage of about 155V and a frequency of 60 Hz. Through the rectifying unit 11, the alternating current signal from the power source 10 is rectified into a pulsed direct current signal having a frequency of 120 Hz. The first capacitor 12 receives the pulsed direct current signal and is charged to the peak voltage V1 for providing the smoothing direct current signal to the light-emitting unit 13. Referring to FIG. 2C, the first capacitor 12 is discharged during the operation of the light-emitting unit 13, and then the peak voltage V1 is dropped to a voltage V2 lower than the peak voltage V1 every cycle of the periodic signal. In this embodiment, the first capacitor 12 has a capacitance value greater than 0.5 mF which is sufficient to provide the smoothing direct current signal having a voltage difference (ΔV) between the peak voltage V1 and the voltage V2 less than 5% of the peak voltage. In one embodiment, the voltage difference (ΔV) between the peak voltage V1 and the voltage V2 is less than 2% of the peak voltage. Preferably, the capacitance value of the first capacitor 12 is less than 100 F.

In addition, in this embodiment, the light-emitting unit 13 comprises a plurality of light-emitting diodes having a total operation voltage of 140V when operated under a current of 10 mA. Therefore, for the light-emitting unit having a power output of 1.4 watts, the first capacitor 12 has a capacitance value greater than 0.5 mF. That is, the first capacitor 12 has a capacitance value greater than 350 μF per watt of power of the light-emitting unit 13.

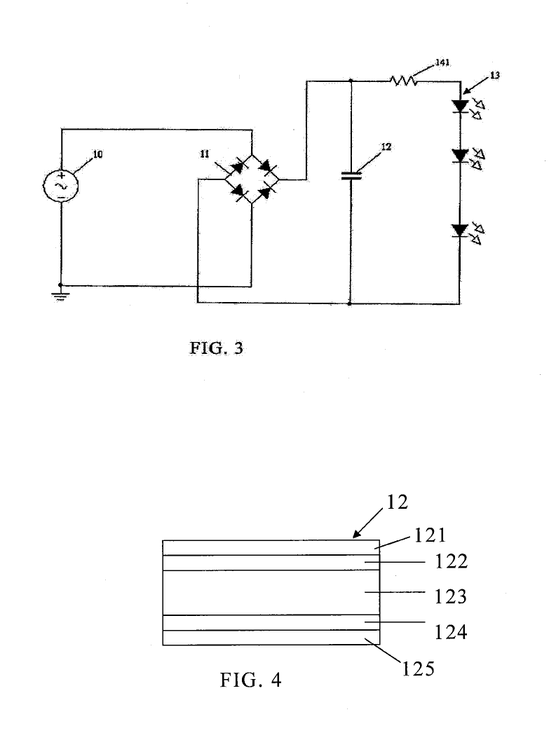

Referring to FIG. 3, a current-limiting unit 141 is electrically connected in series with and between the first capacitor 12 and the light-emitting unit 13 for limiting the current to flow through the light-emitting unit 13. Alternatively, the current-limiting unit 141 is electrically connected between the rectifying unit 11 and the first capacitor 12. In this example, the current-limiting unit 141 is a resistor of 1.5 kΩ and the capacitance value of the first capacitor 12 is 6.8 mF. Therefore, the difference (ΔV) between the peak voltage V1 and the voltage V2 is 0.02% of the peak voltage. In one embodiment, the current-limiting unit 141 can be a constant current diode (CCD), or a current-regulating diode (CRD).

Referring to FIG. 4, the first capacitor 12 comprises a first metal plate 121, a first conductive plate 122, a second conductive plate 124, a non-conductive layer 123 sandwiched between the first and second conductive plates 122, 124, and a second metal plate 125. Each of the first and second metal plates 121, 125 comprises Al, Cu, or Ag. Each of the first and second conductive plates 122, 124 comprises magnetic materials. The non-conductive layer 123 is made of a dielectric material comprising hafnium silicate, zirconium silicate, hafnium dioxide, zirconium dioxide, titanium oxide, barium titanium oxide, silicon oxide, perovskite-oxide such as CaCu₃Ti₄O₁₂, or combinations thereof. The non-conductive layer 123 can also be a multilayer. The first capacitor 12 has a size smaller than 1.5 cm×1.5 cm×1.0 cm and is capable of integrating with a light-emitting chip or a package of a light-emitting device. Moreover, the first capacitor 12 can further comprises a nanostructure (not shown) interposed between the first conductive plate 122 and the non-conductive layer 123 and/or between the second conductive plate 124 and the non-conductive layer 123. In another embodiment, the non-conductive layer 123 has opposite surfaces which are roughed by conventional methods, such as wet etching or sandblasting, for increasing the area surface, thereby enhancing the capacitance value.

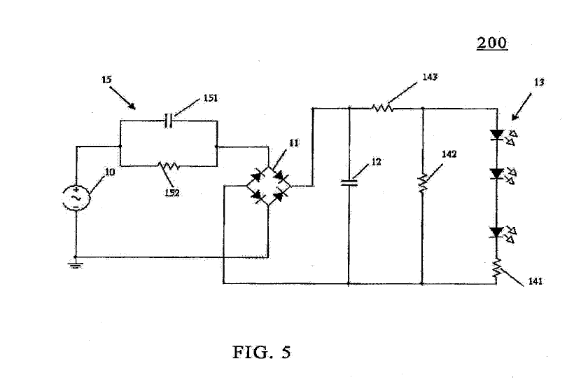

FIG. 5 discloses a light-emitting device 200 according to the second embodiment of the present disclosure. The second embodiment of the light-emitting device 200 has the similar structure with the first embodiment of the light-emitting device 100 except that the light-emitting device 200 further comprises a constant current circuit 15 electrically connected between the power source 10 and the rectifying unit 11. The constant current circuit 15 comprises a second capacitor 151 and a resistor 152 electrically connected in parallel with the second capacitor 151. The constant current circuit 15 provides a constant current to the light-emitting unit 13. According to the equation:

$$Xc = \frac{1}{2 π fC}$$

Xc represents the capacitive impedance of the second capacitor 151, f represents the frequency of the alternating current signal, and C represents the capacitance value of the second capacitor 151. For example, when the capacitance value of the second capacitor 151 is 245 nF and the frequency of the alternating current signal is 60 Hz, the capacitive impedance of the second capacitor 151 is about 11000Ω, which is much lower than the resistor 152 (for example 1.5 MΩ). If the alternating current power source 10 provides a voltage having a root mean square value of 110V, the current in circuit is of about 10 mA. Depending on the actual requirements, the capacitance value of the second capacitor 151 is selected in accordance with the desired current appropriate for the light-emitting unit 13. In addition, a product multiplied by the resistance of the resistor 152 and the capacitance value of the first capacitor 12 is less than 0.6, which indicates the time required to discharge the second capacitor 151 from the peak voltage to 36.7% of the peak voltage is less than 0.6 sec.

The second capacitor 151 comprises two conductive plates and a dielectric layer sandwiched between the conductive plates. The dielectric layer is made of a material comprising hafnium silicate, zirconium silicate, hafnium dioxide, zirconium dioxide, titanium oxide, barium titanium oxide, silicon oxide, polyglycolic acid, polypropylene, polystyrene, polycarbonate, mica, or combinations thereof.

Referring to FIG. 5, the second embodiment of the light-emitting device 200 further comprises a first resistor 142 connected in parallel with and between the first capacitor 12 and the light-emitting diodes 13, and a second resistor 143 in series with and between the first capacitor 12 and the first resistor 142. The first and second resistors 142, 143 are provided for the first capacitor 12 to discharge when the power source 10 is disconnected. In the embodiment, the first resistor 142 has a first resistance (R1) and the second resistor 143 has a second resistance (R2). A product multiplied by the sum of the first and second resistance (R1+R2) and the capacitance value of the first capacitor 12 is less than 0.6, which indicates the time required to discharge the first capacitor 12 from the peak voltage to 36.7% of the peak voltage is less than 0.6 sec.

It will be apparent to those having ordinary skill in the art that various modifications and variations can be made to the devices in accordance with the present disclosure without departing from the scope or spirit of the disclosure. In view of the foregoing, it is intended that the present disclosure covers modifications and variations of this disclosure provided they fall within the scope of the following claims and their equivalents.

What is claimed is:

1. A light-emitting device adapted for receiving an alternating current signal from a power source, the light-emitting device comprising:
a rectifying unit for receiving and regulating the alternating current signal into a first direct current signal;
a first capacitor electrically connected in parallel with the rectifying unit and for receiving and regulating the first direct current signal to a second direct current signal; and
a light-emitting unit electrically connected in parallel with the first capacitor and receiving the second direct current signal;
wherein the second direct current signal is a periodic signal, and the second direct current signal has a maximum voltage and a minimum voltage that the voltage difference between the maximum and minimum voltages is less than 5% of the maximum voltage in one cycle of the periodic signal.

2. The light-emitting device of claim 1, wherein the voltage difference between the maximum and minimum voltages is less than 2% of the maximum voltage.

3. The light-emitting device of claim 1, wherein the first capacitor has a capacitance value greater than 0.5 mF.

4. The light-emitting device of claim 1, wherein the first capacitor has a size small than 1.5 cm×1.5 cm×1.0 cm.

5. The light-emitting device of claim 1, further comprising a current-limiting unit electrically connected in series with and between the first capacitor and the light-emitting diodes.

6. The light-emitting device of claim 1, further comprising a resistor connected in parallel with and between the first capacitor and the light-emitting diodes.

7. The light-emitting device of claim 1, further comprising a current constant circuit electrically connected between the power source and the rectifying unit, wherein the current constant circuit comprises a second capacitor and a resistor electrically connected in parallel with the second capacitor.

8. The light-emitting device of claim 1, wherein the first capacitor comprises a first conductive plate, a second conductive plate, and a non-conductive layer between the first and second conductive plates, wherein each of the first and second conductive plates comprises magnetic materials.

9. The light-emitting device of claim 8, wherein the non-conductive layer is made of a dielectric material comprising hafnium silicate, zirconium silicate, hafnium dioxide, zirconium dioxide, titanium oxide, barium titanium oxide, silicon oxide, perovskite-oxide, or combinations thereof.
